(19) United States
(12) Patent Application Publication
(10) Pub. No.: US 2012/0111222 A1
(43) Pub. Date: May 10, 2012

(54) Amusement Device

(75) Inventors: Giambattista Zambelli, Ceneselli (RO) (IT); Fiorella Viarana, Caneselli (RO (IT)

(73) Assignee: ANTONIO ZAMPERLA S.P.A., Altavilla Vicentina (IT)

(21) Appl. No.: 13/128,994

(22) PCT Filed: Nov. 12, 2008
(86) PCT No.: PCT/IT08/00705

§ 371 Date: Jan. 10, 2012

(51) Int. Cl. A63G 4/00; B60R 21/00

(52) U.S. Cl. 104/53

(57) ABSTRACT

An amusement device includes at least one platform movable with respect to a fixed chassis, in which the at least one platform includes at least one compartment to accommodate one or more passengers. The at least one compartment has no seating and includes an arrangement for manually supporting the one or more passengers who are disposed standing freely inside the at least one compartment.

### CROSS-REFERENCE TO RELATED APPLICATION

This application is the National Stage of International Application No. PCT/IT2008/000705, filed Nov. 12, 2008, the entire contents of which are expressly incorporated herein by reference.

### FIELD OF INVENTION

The present invention relates to an amusement device. In particular, the amusement device in question is used, for example, in funfairs and theme parks and, according to prior art, comprises a platform which moves along a track, or is suspended from a moving arm, and which is also provided with compartments to accommodate passengers.

### BACKGROUND INFORMATION

For example, European Patent No. EP 1 551 519 by the same Applicant describes a platform capable of sliding along a track, and of rotating about a central axis substantially orthogonal to the support surface of the amusement device. The compartments to accommodate passengers, disposed on top of the platform, comprise special seats which are capable of holding the passenger firmly restrained. In this manner, each passenger is subjected to a translational and rotational movement capable of providing him with a high degree of amusement and excitement.

International Patent Publication No. WO 2007/136245, by the applicant VEKOMA RIDES ENGINEERING B.V., describes an amusement device comprising a platform movable along a track, wherein the platform is provided with one or more compartments to accommodate at least one passenger. Each compartment is formed of a seat capable of allowing the passenger to move upwards, e.g., from seated to standing, and vice versa. The seat is also provided with means to hold the passenger restrained thereto during operation of the device. In this manner, not only is the passenger subjected to a rotational and translational movement, but can also stand up and sit down during sliding, or rotation, of the platform along the track.

However, these types of amusement rides are not without drawbacks. In fact, the passenger, in the case in which the forces to which he is subjected are not excessively high, is unable to move freely, i.e., to move his body as desired in such a manner as to accompany the movements of the platform during its evolutions along the track, but for safety reasons is restrained to the seat. Therefore, at relatively low operating speeds and accelerations, the prior art amusement device loses its reason for existing as the movements of the passenger are limited to only those made possible by the seat, making travel of the platform along the tracks boring and rather unexciting.

Therefore, there is the need to increase the amusement of passengers in relatively inexpensive devices such as those of the type comprising a platform movable along a path of the type, for example, in which a track is present with respect to which the platform translates and/or rotates or an arm from which the platform is suspended and with respect to which it can rotate.

### SUMMARY OF THE INVENTION

The object of the present invention is to solve the problems described above.

This object is achieved by means of the invention which provides an amusement device of the type comprising a platform movable along a path, which allows the passenger to move freely while remaining restrained, in a safe manner, to his accommodation compartment.

A further object of the present invention is to produce such a type of amusement device which also ensures a high degree of safety.

These and other objects are achieved by the present amusement device comprising at least one platform movable along a path, wherein said at least one platform comprises at least one compartment to accommodate one or more passengers, characterized in that said at least one compartment has no seating and comprises means to support said one or more passengers, said supports being grippable by passengers standing inside said at least one compartment.

In this manner the passenger, by clinging to the support means with his hands, can remain restrained to the accommodation compartment, but can also move freely, standing inside this compartment. This is made possible by the fact that the compartment has no seating and has no passive retention means for the user, so that the passenger is not obliged to remain restrained to the seat, but can move freely during the evolutions of the platform.

In a preferred embodiment, the amusement device according to the invention is provided with a platform which can translate and/or rotate with respect, for example, to a track, or to an arm from which the platform is suspended, or to other similar means, without departing from the scope of protection of the present invention.

According to the invention, the support means comprise at least one substantially U-shaped railing, preferably covered with shockproof material. This allows the passenger to have his own space with respect to which he can move freely, while remaining restrained to the support means.

Again according to a first embodiment of the device according to the invention, said at least one U-shaped railing is disposed, at least partly, along the perimetrical portion of said platform and such in a manner that the open side of this railing is facing the inside of the platform.

The device comprises further means for closing/opening the open side of said at least one U-shaped railing of said at least one compartment. In this manner it is possible to enclose the passenger inside an at least partly closed area. This area thus defines the compartment to accommodate a single passenger or more than one passenger. This ensures a satisfactory degree of safety for passengers during the evolutions of the amusement device.

Preferably, the closing/opening means comprise at least one element, in general covered with shockproof material, which is movable between a first position in which it defines, with the railing, an at least partly closed compartment, to enclose one or more passengers, and a second position in which said railing and said element define an open compartment, for one or more passengers to enter or exit through the open side of said railing.

Advantageously, the device comprises means for rotation of said at least one element about an axis parallel to the open side of said at least one railing, between said first and said second position, and vice versa.

In accordance with a third embodiment, the device comprises means for sliding of said closing element handle along an axis substantially perpendicular with respect to the open side of said one or more U-shaped railings.

In both the cases mentioned above, the device comprises means to lock the closing element at least in said first position, in which the compartment is closed.

### BRIEF DESCRIPTION OF THE DRAWINGS

One or more particular embodiments of the present invention are now described in greater detail with reference to the accompanying drawings provided by way of non-limiting example.

FIG. 1 is a perspective top view of an amusement device according to the present invention.

FIG. 2 is a perspective view of the amusement device of FIG. 1.

FIG. 3 is an axonometric view of the closing/opening means of the device of FIG. 2.

FIG. 4 is a perspective view of the locking means of the device of FIG. 3.

With reference to these figures, the generic amusement device according to the invention is indicated with reference numeral 1.

### DETAILED DESCRIPTION

According to a first embodiment of the invention, the amusement device 1 comprises a platform 2, movable along a chassis (not shown here), and provided with compartments 4 to accommodate a passenger 5. Although not described herein, a compartment 4 can also accommodate more than one passenger without departing from the scope of protection of the present invention. Preferably, the platform 1 can rotate and simultaneously slide with respect to the chassis so that the passenger located inside a compartment 4 is subjected to both a translational and rotational movement, for example by means of the structure described in EP 1 551 519, incorporated herein by reference. In other embodiments, the platform can be movable, in rotation, with respect to a mechanical arm, which translates during operation of the device 1. In general, the platform is translated according to the direction of the axis X and the passengers are disposed along the edges of the platform so as to be facing the outside of the device.

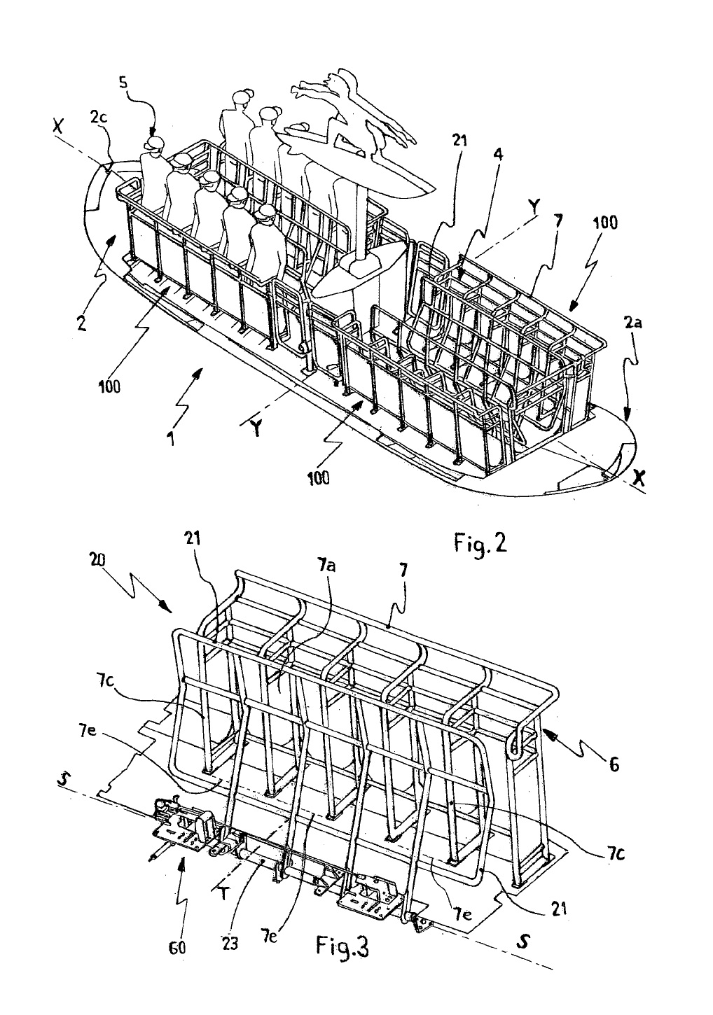

According to the invention, each compartment 4 comprises means 6 for a passenger 5 to manually support himself (as shown in FIG. 2), in such a manner that he can remain standing, free to move, inside the compartment 4, gripping the support means 6 if he so wishes or when this is necessary due to movement of the device. Otherwise, the passenger can decide not to grip the support railing 6 and remain standing without help; the railing 7 in any case forms a protective support, in particular together with a further closing element of the compartment 4, described below.

These support means 6 comprise a substantially U-shaped railing 7 which delimits, in part, the compartment 4 to accommodate the passenger 5. This railing 7 is covered with a shockproof material 22, for example rubber or foamed material, and can be gripped by the passenger during operation of the amusement device 1. In practice, according to the invention, the railing 7 forms the support means 6 grippable by the passenger and the compartment or compartments 4 which accommodate the passenger.

According to the embodiment described here, the railing 7 is produced by welding suitable tubular elements 70. It must also be noted that the generic compartment 4 has no seating as in the device 1 according to the invention the passenger 5 is not restrained to an element integral with the platform 2, but can move freely on the platform during the evolutions thereof.

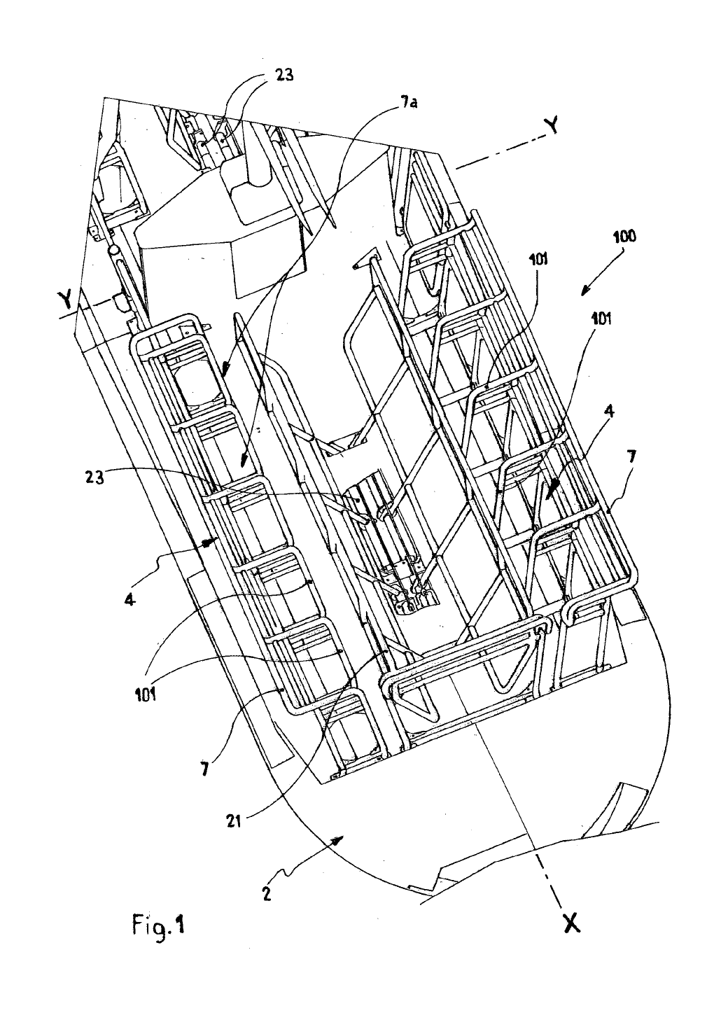

Preferably, the compartments 4 are disposed in a continuous manner, as shown in the figures, thereby forming a plurality of compartments 100, so that the railings 7 are also mutually aligned in a continuous manner. In FIG. 1, for reasons of simplicity, only two plurality 100 of continuous compartments are shown, disposed symmetrically with respect to the longitudinal axis X of the device. However, it can be observed that the platform 2 of FIG. 1 comprises another two pluralities 100 of continuous compartments, symmetrical to the two pluralities of compartments 100 illustrated with respect to the transverse axis Y of the platform 2, in order to ensure the equilibrium of the load that is placed on the platform 2. Moreover, all the compartments 4 are disposed along the perimetrical portion 2a of the platform 2, in such a manner that the open side 7a of each railing 7 is facing the inside 2b of the platform 2.

Moreover, although not illustrated here, it can be observed that the compartments 4 can have different dimensions, in such a manner as to accommodate more or fewer people. For example, one of the four pluralities 100 of compartments can be transformed into a single compartment elongated longitudinally with respect to the platform 2. This can be done by removing partitions, producing a railing without the partitions 101 provided between one compartment 4 and the other in the previous configuration. Preferably, the device presents a plurality of single compartments, i.e., each compartment 4 accommodates one passenger.

The device 1 also comprises means 20 for closing/opening the compartments 4. This occurs by means of a movable element to close the open side 7a of each railing 7 of each of the four pluralities of compartments to accommodate passengers 5.

These closing/opening means 20 comprise, as shown in FIG. 3, a closing element 21 which is mounted along the longitudinal axis X of the platform and is movable to open and close the compartment 4 defined by the railing 7. In the preferred embodiment shown, the closing element 21 is formed by a plurality of tubings constrained to provide a second railing mounted vertically, and pivoted to the load-bearing structure of the platform to be movable between a first and a second position with respect to the fixed railings 7. More particularly, the closing element 21 is movable between a first position in which each railing 7 of said plurality of compartments 100 and said element 21 define several substantially closed compartments 4, to enclose at least one passenger 5 inside each compartment 4, and a second position in which each railing 7 of said plurality of compartments 100 and said element 21 define several open compartments 4, for one or more passengers 5 to enter or exit through the open side 7a of each railing 7.

The element 21, in the closed position thereof, preferably does not reach the ends 7c of the partitions of each railing 7, that is, it is not in contact therewith, but stops at a safety distance. This distance is sufficiently small to still allow the element 21 to form a containing structure for the passenger during operation of the device 1.

In the embodiment shown, the closing elements 21 are four in number, as there are four pluralities 100 of compartments disposed symmetrically with respect to the longitudinal X and transverse Y axes of said platform 2 and in the central portion 2b of the platform 2. In practice, therefore, while the compartments 4 are on the periphery 2a of the platform 2, the closing elements 4 are located in the central region 2b of this platform 2.

In other embodiments of the invention, the compartments 4 are disposed in the central portion 2b of the platform 2, while the closing elements 21 are disposed in the peripheral portion 2a. In this manner, the compartments 4 are disposed in such a manner that the open side 7a of each railing 7 is oriented towards the outside of the platform. Alternatively, the railings are disposed transversely to the axis X, or at an acute angle thereto. In this latter case, the open side 7a of each railing 7 is generally facing the central part of the platform 2.

Therefore, in practice, when the closing elements are located in the first position, the compartments 4 almost completely enclose the passenger 5 therein, guaranteeing the safety thereof; on the contrary, when the handles 4 are located in the second position, these are distant from the railings 7. In this second case each compartment 4 of each plurality of compartments 100 is completely open and capable of allowing the passenger 5 to enter or exit the compartment 4 through the open side 7a of each railing 7.

As mentioned above, the elements 21, just as the railing 7, are covered with shockproof material 22, in such a manner that during the movements of the platform, even if the passenger 5 unintentionally loses his grip on the support means 6, the shockproof material 22 is capable of violent cushioning any knocks the passenger 5 may sustain against the closing element 21 or against the railing 7.

The closing elements 21 are in the form of a railing or grating and comprise a lower shaft 23 which acts as a base and which is pivoted rotatingly on the platform structure 1. Leading from this axis 23 are some uprights 24, which are mutually joined by means of other tubings 25 parallel to the platform. The device 1 is provided with means to block rotation of the closing element 21 about an axis S parallel, in this specific case, to the longitudinal axis X of the platform and to the open side 7a of each railing 7 of the plurality 100 of compartments with respect to which the element 21 operates, between said first and said second position, and vice versa.

In accordance with a further embodiment of the invention, not illustrated herein, the device 1 is provided with means to make the closing element 21 slide along an axis T perpendicular to the open side 7a of each railing 7 of the plurality 100 of compartments with respect to which said element 21 operates, between said first and said second position, and vice versa.

In both the embodiments in which the closing/opening means 21 are present, the device 1 comprises means 60 to lock each element 21 in said first and second position, in such a manner that when the amusement device 1 is stopped or is operating, the passenger can respectively enter/exit the compartment 4 and remain in safety inside the compartment 4. Preferably, the elements 21 are mounted idle on the platform and are rotated manually; gas springs (not shown) are provided to maintain the elements 21 in the rest position, i.e., in the open position.

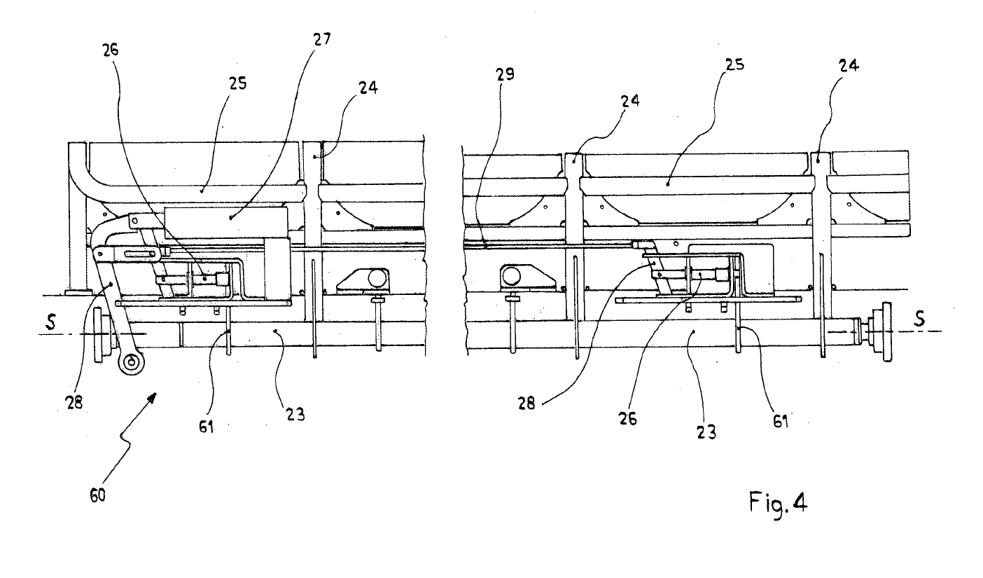

As shown in FIGS. 3 and 4, which refer to the embodiment in which the elements 21 are rotated between the open position and the closed position of the compartment 4, to maintain the elements 21 in the closed position the locking means 60 comprise a pair of plates 61 solidly constrained to the base tubing of the element 21. These plates 61 are provided with seats structured to couple, and to remain constrained, each with the end of a pin 26 which can be actuated by a linear actuator 27. The linear actuator is, for example, of hydraulic, pneumatic or electric type. It controls the movement of two levers 28 mutually connected by a rod 29 which transmits movement. The two levers each translate a pin 26 which engages the plate and, following rotation of the plate, the locking seat of this plate.

It is observed that, although several embodiments have been described above in which the compartments 4 are mutually joined so as to form one or more pluralities 100 of continuous compartments, an embodiment in which the compartments 4 are separate from one another also falls within the scope of protection of the present invention. Likewise, an amusement device 1 in which the compartments 4 are separate from one another and which uses for each compartment 4 a handle 21 also falls within the scope of protection of the present invention.

It is also observed that, unlike the description above, the compartments 4 can also be disposed in such a manner that the open side 7a of each railing 7 is substantially parallel to the transverse axis Y of the platform 7.

According to the operating diagram of the amusement device 1, when it is in the loading position, the closing elements 21 are located in their second position, allowing the passengers 5 to climb onto the platform and to enter a compartment 4. As shown in FIG. 2, the closing elements or gratings 21 are located in the central region 2b of the platform 2, and their second position, i.e., the rest position in which the elements 21 are rotated vertically and located along the central axis of the platform, allows a considerable saving of space to be achieved.

Before the amusement device 1 starts to operate, the elements 21 are taken to their working position, in such a manner that the passengers are at least substantially enclosed standing inside their compartment 4. Each passenger 5 can cling to the relative support means 6, while being able to move while standing in a substantially free manner inside the compartment 4 so that he is able to keep his balance on the platform and imitate the movements made on a real surfboard. At the end of the amusement device 1 ride, the elements 21 are returned to their second position to allow the passenger to exit his accommodation compartment 4.

1-11. (canceled)

12. An amusement device for transporting passengers, comprising:
at least one movable platform having an arrangement to accommodate at least one passenger, comprising:
at least one compartment to accommodate the at least one passenger;
and
a support arrangement to support the at least one passenger, the support arrangement being grippable by the passenger standing inside the at least one compartment.

13. The amusement device according to claim 12, wherein the support arrangement comprises at least one railing which defines the at least one compartment.

14. The amusement device according to claim 13, wherein the at least one compartment has no seating and is located, at least partly, along a perimetrical portion of the at least one platform.

15. The amusement device according to claim 14, wherein the railing is U-shaped, and an open side of the U-shaped railing faces an inside of the platform.

16. The amusement device according to claim 13, further comprising:
a closing/opening arrangement for closing/opening an open side of the at least one railing of the at least one compartment.

17. The amusement device according to claim 16, wherein the closing/opening arrangement comprises at least one closing element which is movable in relation to the railing between a first position in which the railing and the closing element define at least one, at least partly closed, compartment, to enclose the at least one passenger, and a second position in which the railing and the closing element define at least one open compartment, for the at least one passenger to enter or exit through the open side of the railing.

18. The amusement device according to claim 17, further comprising:
a rotation arrangement for rotation of the closing element about an axis substantially parallel to the open side of the railing, between the first and second positions, and vice versa.

19. The amusement device according to claim 17, further comprising:
a sliding arrangement for sliding the closing element along an axis substantially perpendicular with respect to the open side of the railing, between the first and second positions, and vice versa.

20. The amusement device according to claim 17, further comprising:
a locking arrangement to lock the closing element in the first position.

21. The amusement device according to claim 20, wherein the locking arrangement comprises an actuator, at least one lever and a pin.

22. The amusement device according to claim 12, further comprising:
at least one track along which the at least one platform at least one of translates and rotates.
